(19) United States
(12) Patent Application Publication
(10) Pub. No.: US 2026/0276161 A1
(43) Pub. Date: Sep. 17, 2026

(54) LED SPOTLIGHT LAMP

(71) Applicant: SIGNIFY HOLDING B.V., EINDHOVEN (NL)

(72) Inventors: XIAOLONG NIE, SHANGHAI (CN); YUNXUAN SHI, SHANGHAI (CN); HUANSI WANG, SHANGHAI (CN); HUIJIE LIU, SHANGHAI (CN); LING XU, SHANGHAI (CN); XIAOQIAO ZHANG, SHANGHAI (CN); YUFENG XU, SHANGHAI (CN); XIAOQING DUAN, SHANGHAI (CN)

(21) Appl. No.: 18/872,344

(22) PCT Filed: Jun. 5, 2023
(86) PCT No.: PCT/EP2023/064928

§ 371 Date: Dec. 6, 2024

(30) Foreign Application Priority Data
Jun. 8, 2022 (WO) PCT/CN2022/097604
Aug. 25, 2022 (EP) 22192138.0

(51) Int. Cl. F21K 9/233; F21V 21/40

(52) U.S. Cl. CPC F21K 9/233; F21V 21/40

(57) ABSTRACT

An LED spotlight lamp (100) having a handle (130) that can be moved or rotated between a folded and an unfolded configuration with respect to a light outputting end of the LED spotlight lamp (100). When in the unfolded configuration, a gripping portion (131) of the handle (130) can be gripped by an individual or person for maneuvering the LED spotlight lamp (100).

### FIELD OF THE INVENTION

The present invention relates to the field of lighting, and in particular to the field of LED spotlight lamps.

### BACKGROUND OF THE INVENTION

There is an increasing use of light emitting diodes (LEDs) in lamps in commercial and domestic settings. As there are a large number of existing light fixtures, there is a strong desire to allow LED spotlight lamps to connect or mount to such existing light features, i.e., to facilitate retrofitting.

It is recognized by this disclosure that one challenge of LED spotlight lamps is in their installation and extraction. In particular, it has been herein recognized that existing LED spotlight lamps are difficult or awkward to grip or grasp. This means that their installation and extraction is complicated, and can be extremely difficult for persons/individuals with mobility concerns or problems to perform quickly or safely.

There is therefore a desire to provide a solution for LED spotlight lamps that resolves at least some of these problems or difficulties.

### SUMMARY OF THE INVENTION

The invention is defined by the claims.

According to examples in accordance with an aspect of the invention, there is provided an LED spotlight lamp.

The LED spotlight lamp comprises: a light emitting element comprising one or more light emitting diodes for generating light; and a lens comprising an optical area or receiving light emitted by the light emitting element and directing the received light out of a light outputting end of the LED spotlight lamp in a light output direction; and a handle comprising a gripping portion for being gripped by an person, the handle being coupled to the light outputting end of the LED spotlight lamp at one or more locations.

The handle is configured to be rotatable between at least: a first position, in which the gripping portion of the handle lies against the light outputting end of the LED spotlight lamp; and a second position, in which the gripping portion of the handle extends outwardly from the light outputting end to facilitate gripping of the LED spotlight lamp by the person for inserting, rotating and/or extracting the LED spotlight lamp with respect to a lamp socket.

The disclosure proposes an LED spotlight lamp having a handle that can be folded to and unfolded from a light outputting end of the LED spotlight lamp. The handle provides a means for gripping and/or engagement by an individual/person, e.g., using one or more digits, being one or more thumbs and/or fingers. This increases an ease for persons/individuals in manipulating the LED spotlight lamp, e.g., inserting, rotating and/or extracting the lamp with respect to a lamp socket.

It is common for spotlight lamps to be installed in recessed cavities (e.g., in a ceiling or wall). In such scenarios, it is difficult to grasp or grip the spotlight lamp, as the light outputting side of the lamp may lie flush with a bound of the cavity or within the cavity itself (meaning there are no exposed parts for the individual to grasp). The handle provides an element that can maneuvered to a position at which it can be gripped or engaged with by a person/individual, thereby increasing an ease of manipulating the lamp, e.g., within the recessed cavity. In other words, the handle is exposable from a light outputting surface or face of the LED spotlight lamp.

In particular, the handle provides an element against which an individual can easily apply a rotational force for rotating the LED spotlight lamp during an installation/extraction procedure. This allows an individual, for instance, to more easily line up a plug of the LED spotlight with a lamp socket and/or to perform any necessary rotation for engaging or connecting the plug of the LED spotlight lamp with the lamp socket (e.g., as required for GU-10/GZ-10 lamps).

In some examples, one or more locations are locations around or outside the perimeter of the optical area. This reduces a likelihood and/or amount of distortion or blocking of light output by the lens through the optical area, lessening an impact on the light output by the LED spotlight lamp.

In some examples, when the handle is in the first position, the gripping portion of the handle lies outside of the optical area. This approach further reduces a likelihood and/or amount of distortion or blocking of light output by the lens through the optical area. Thus, when in the first position, the handle may not cover the optical area (e.g., not extend over the optical area).

In some embodiments, the lens comprises a bounding area that surrounds the optical area and is configured to not directly receive light emitted by the light emitting element. When the handle is in the first position, the gripping portion of the handle may lie inside the bounding area. Positioning the handle to lie inside the bounding area thereby reduces or avoids distortion or blocking of light output by the lens.

The lens may further comprise, adjacent to the gripping portion of the handle when the handle is in the first position, a recess for the person to access the gripping portion of the handle. The recess thereby provides an approach for allowing the individual to access the handle, to allow or permit the individual to move the handle from the first position to the second position.

When the handle is in the first position, the gripping portion of the handle may be inset within a handle recess. This reduces an exposure of the handle from the light outputting end of the LED spotlight lamp, further reducing a likelihood and/or amount of distortion or blocking of light output by the LED spotlight lamp.

In some examples, when the handle is in the second position, the gripping portion of the handle forms an arch over the optical area. An arch provides an ergonomic shape for holding by the person/individual. An arch also provides a suitably high-strength shape for reducing a chance of breakage or snapping of the handle from the LED spotlight lamp.

The handle may be coupled to the lens at one or more locations around or preferably outside the perimeter of the optical area. This further reduces an exposure of the handle from the light outputting end of the LED spotlight lamp, further reducing a likelihood and/or amount of distortion or blocking of light output by the LED spotlight lamp.

In some examples, the lens and handle geometrically co-operate to define one or more hinges to facilitate rotation of the handle with respect to the lens. In particular, the handle may be mounted or rotatably coupled to the lens itself. This approach provides good structural integrity for the handle connections, by providing a strong base against which a force can be applied by a person.

Each of the one or more hinges may comprise: a hinge recess, being a recess inside a side edge of the lens; and a hinge portion, being a portion of the handle that extends into the hinge recess for rotatably engaging with the hinge recess.

The hinge recess may be formed in a hinge area of the lens outside of the optical area, wherein the hinge area lies flush with the optical area.

The LED spotlight lamp may further comprise one or more protrusions, wherein each protrusion extends outwardly from the light outputting end of the LED spotlight lamp and the handle is coupled to the light outputting end of the LED spotlight lamp at the location of each protrusion.

The optical area may lie in a first plane and each protrusion may extend in a direction substantially perpendicular to the first plane. The protrusion(s) provide a base for the handle, reducing a likelihood that the base of the handle will snap or break, e.g., when the person applies a rotational force to the handle for rotating the LED spotlight lamp. The protrusion(s) also provide a means for maneuvering the LED spotlight lens should the handle break or snap, thereby providing redundancy in maneuvering of the LED spotlight lens.

The LED spotlight lamp may be configured and arranged as a GU/GZ LED spotlight lamp. The LED spotlight lamp may be configured and arranged as a GU-10 lamp or a GZ-10 lamp.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 provides an exploded view of a LED spotlight lamp;

FIG. 2 provides a perspective view of the LED spotlight lamp in assembled form;

FIG. 3 provides another perspective view of the LED spotlight lamp;

FIG. 4 provides a side view of the LED spotlight lamp;

FIG. 5 provides a top or front view of the LED spotlight lamp;

FIG. 6 provides a cross-sectional view of the LED spotlight lamp;

FIG. 7 provides a cross-sectional view of a hinge for an LED spotlight lamp;

FIG. 8 provides a cross-sectional view of a hinge for a variation of the LED spotlight lamp;

FIG. 9 provides a cross-sectional view of another variation of the LED spotlight lamp;

FIG. 10 provides a cross-sectional view of a hinge for the other variation of the LED spotlight lamp;

FIG. 11 provides a perspective view of the other variation of the LED spotlight lamp;

FIG. 12 provides another perspective view of the other variation of the LED spotlight lamp; and

FIG. 13 provides a side view of the other variation of the LED spotlight lamp.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an LED spotlight lamp having a handle that can be moved or rotated between a folded and an unfolded configuration with respect to a light outputting end of the LED spotlight lamp. When in the unfolded configuration, a gripping portion of the handle can be gripped by an individual or person for maneuvering the LED spotlight lamp.

Embodiments are based on the realization that a handle can aid in the gripping or engaging of the LED spotlight lamp, but that a fixed handle would interrupt or block light emitted by the LED spotlight lamp. By providing a rotatable handle that can be folded against the light emitting side of the LED spotlight lamp, the amount of light blocked can be significantly reduced or even completely avoided, whilst still providing a highly maneuverable lamp.

Embodiments of the invention can be employed in any environment or scenario in which LED spotlight lamps are provided, such as domestic, commercial, industrial, public and/or clinical settings.

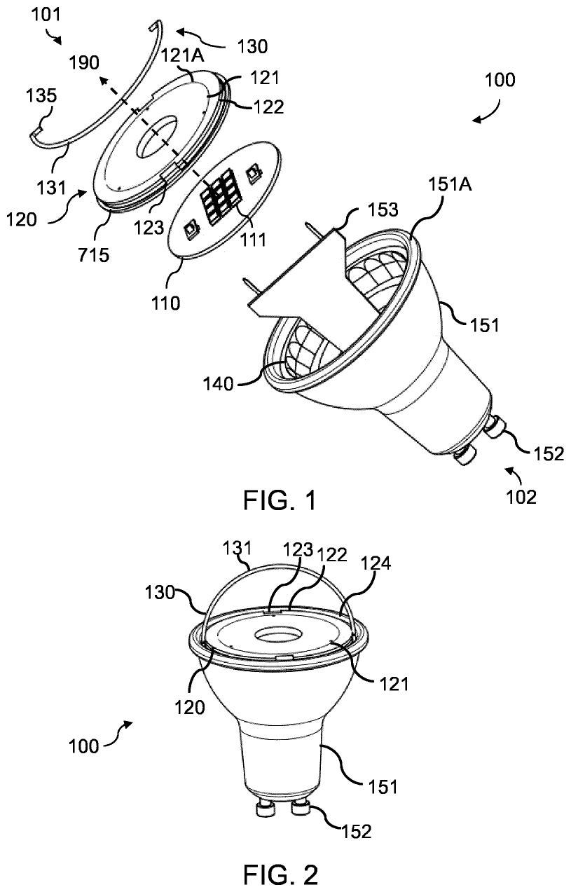

FIG. 1 provides an exploded view of an LED spotlight lamp 100 according to an embodiment, to illustrate various components that form an LED spotlight lamp 100. FIGS. 2 to 5 provide different views of the same LED spotlight lamp in assembled form.

The LED spotlight lamp 100 comprises a light emitting element 110, a lens 120, a reflector 140, a housing 151, a plug 152 and a driver or power supply 153.

The LED spotlight lamp 100 can define a light outputting end 101 or front end (from which light is output) and a socket connecting end 102 or rear end (for connecting to a lamp socket).

The light emitting element 110 comprises one or more light emitting diodes 111 (LEDs). Each light emitting diode 111 is configured for generating light, as is well known in the art. The light generated by the light emitting element 110 is transmitted or passed to an optical area 121 of the lens 120. This may be performed via direct transmission from the light emitting element 110 to the optical area 121 of the lens 120 and/or via one or more reflections by the reflector 140.

The lens 120 thereby comprises an optical area 121 for receiving light emitted by the light emitting element. The optical area 121 is configured to direct received light out of a light outputting end 102 of the LED spotlight lamp.

In particular, the optical area 121 is configured to direct received light out of the LED spotlight lamp 100 in a light output direction 190 from the light outputting end 101 of the LED spotlight lamp 100. A light output direction 190 may be defined as the optical axis or central axis of light output by the LED spotlight lamp 100. It will be appreciated that the LED spotlight lamp 100 may output (when powered) a beam of light having a beam spread. The central axis of the beam of light defines the light output direction.

The optical area 121 may comprise a diffuser for diffusing light received from the light emitting element.

The optical area 121 may be coated with a protective layer, which does not need to form part of the lens 120. In some examples, the protective layer performs further light modifying actions, such as color or polarity filtering and/or light diffusion.

As previously mentioned, the reflector 140 is configured to direct light incident upon the reflector 140 towards the lens. The reflector may be conical in shape, or any other suitable shape for directing light towards the lens 120.

The housing 151 is configured to house and/or support the other elements of the LED spotlight lamp 100. In particular, the lens 120 may be held at/by the light outputting end of the housing 151, and the light emitting element 110 and the reflector 140 may be enclosed by the lens and the housing 151. The housing 151 may provide structural support to the other components of the LED spotlight lamp 100.

The plug 152 provides a means for electrically and mechanically connecting the LED spotlight lamp 100 to a lamp socket (not shown), thereby providing an electrical connection to a power supply connected to the lamp socket. The illustrated plug 152 comprises a pair of pins for electrically and mechanically connecting the LED spotlight to corresponding pin sockets of a lamp socket (not shown). The plug 152 extends from a socket connecting end 102 of the LED spotlight lamp.

The housing 151 and/or plug 152 may be appropriately adapted or configured to provide different types of LED spotlight lamp 100. For instance, the configuration of the housing, particularly the base of the housing surrounding the plug 152, may define whether the LED spotlight lamp is a GU-type or a GZ-type.

The configuration of the plug 152 (e.g., a distance between the pins or structure of the pins) also defines different types of LED spotlight lamp. For instance, GU-10 and GZ-10 LED spotlight lamps have pins that define a twist-and-lock mechanism using two pins spaced 10 mm apart.

The driver or power supply 153 provides an electrical connection between the light emitting element 130 and the plug 152, to electrically connect the light emitting element to a lamp socket (and therefore power source) when the plug is electrically connected to a lamp socket. The driver or power supply 153 also converts a power provided at the plug 152 into a form suitable for driving the light emitting element 130. For instance, the driver or power supply 152 may comprise a rectifier and/or decoupling arrangement.

The LED spotlight lamp 100 further comprises a handle 130. The handle is positioned or located at the light emitting end 101 of the LED spotlight lamp 100, and is coupled to the light emitting end 101 at one or more locations.

The handle 130 comprises a gripping portion 131 for being gripping by a person or individual. The gripping portion 131 is therefore suitable sized and/or shaped for being held by a person or individual.

The handle 130 is rotatable between at least a first position and a second position.

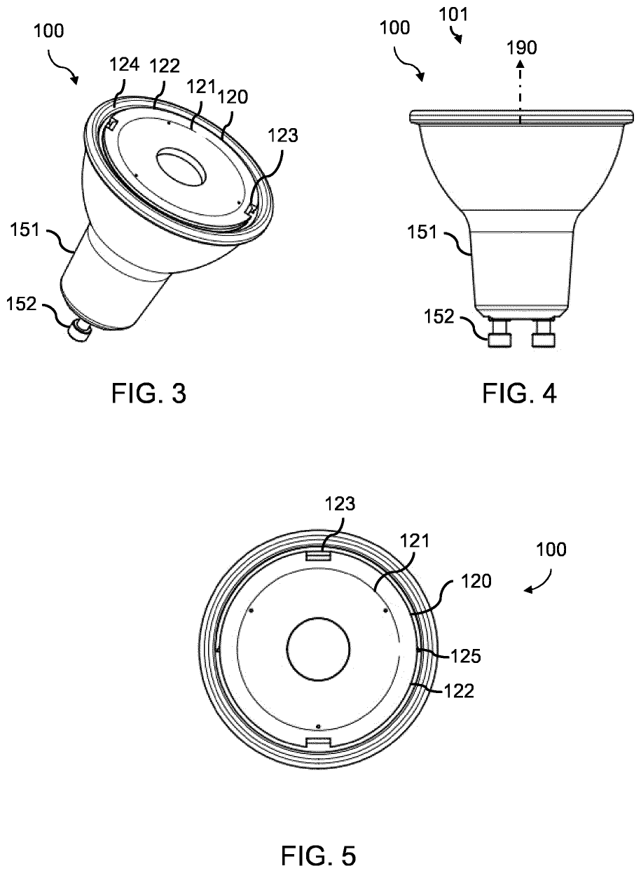

FIG. 2 provides a perspective view of the LED spotlight lamp 100 when the handle 130 is in the second position. FIGS. 3 to 5 illustrates the LED spotlight lamp 100 when the handle 130 is in the first position. FIG. 3 provides a perspective view, FIG. 4 provides a side view and FIG. 5 provides a top view, e.g., a view of the light output side of the LED spotlight lamp.

In the first position, the gripping portion 131 of the handle lies against the light outputting end 101, i.e., is not exposed for being held or gripped by the person/individual. In the second position, the gripping portion extends outwardly from the light outputting end 101. i.e., is exposed for being held or gripped by the person/individual.

Put another way, the first position represents a folded position in which the gripping potion 131 of the handle 130 is folded against the light outputting end 101 of the lamp. The second position represents an unfolded position, in which the gripping portion 131 of the handle 130 is unfolded from the light outputting end 101 of the lamp 100 to facilitate holding or gripping of the handle by a person/individual.

Thus, when the handle is in the second position, the gripping portion of the handle extends outwardly from the light emitting side to facilitate gripping of the LED spotlight lamp by the person for inserting, rotating and/or extracting the LED spotlight lamp with respect to a lamp socket.

This approach means that a handle can be provided for ease of manipulating the LED spotlight lamp with respect to the lamp socket during installation and/or extraction of the LED spotlight lamp, whilst also allowing the handle to be hidden away or its exposure reduced, to minimize the effect of the handle on light output characteristics (e.g., reduce light blocking) of the light output by the LED spotlight lamp, e.g., once the lamp has been installed in a lamp socket.

The proposed approach thereby provides an LED spotlight lamp with improved installation/extraction ease, whilst having no or negligible effect on the light output by the LED spotlight lamp once it is installed, e.g., meaning that existing lens structures and types can be used without significant modification.

In particular, the handle 130 is rotatable about (e.g., only) an axis perpendicular to the light output direction 190. This approach means that force can be applied by a person to the handle to rotate the LED spotlight lens about a rotation axis in the same direction as the light output direction 190 without causing the handle to move or rotate with respect to the LED spotlight lamp. This approach facilitates rotation of the LED spotlight lamp using the handle, e.g., during installation and/or extraction of the LED spotlight lamp from a lamp socket.

The one or more locations, to which the handle is coupled to the light emitting end, may be around or outside the perimeter 121A of the optical area 121 of the lens 120. This approach (further) reduces or avoids interaction with any light output by the lens 120 and/or any distortion or blocking of any light output by the lens 120.

As illustrated in FIG. 1, the optical area 121 occupies a central region or area of the lens. The one or more locations (to which the handle couples) can thereby be positioned outside a central region of the lens.

In preferable examples, the one or more locations (to which the handle couples) are positioned to be more proximate to an edge of the LED spotlight lamp 100 and/or an edge of the lens 120 than a center of the lens 120. This allows an individual to apply a greater moment/torque for rotating the LED spotlight lamp with increased ease, compared to location(s) closer to the rotational axis of the LED spotlight lamp.

In particular, the distance between each of the one or more locations (to which the handle couples) and an edge of the lens 120 may be no more than half the distance between each of the one or more locations (to which the handle couples) and a center of the lens 120, e.g., no more than a quarter of the distance between each one or more locations (to which the handle couples) and a center of the lens 120.

The handle 130 may be formed from any suitable material, such as plastic, metals or the like. Preferably, the handle is formed from an insulating material, such as plastic, to reduce the chances of accidental or unintentional conduction of electricity to the individual, e.g., should there be an electrical short to the handle from the light emitting element 110.

The gripping potion 131 may have a textured or coated surface to increase its effective friction (e.g., compared to a smooth surface). This approach increases an ease and strength of gripping of the handle by a person, e.g., to prevent or reduce a likelihood of the person's fingers from unintentionally slipping from the handle when installing, rotating and/or extracting the LED spotlight lamp from a lamp socket.

In preferable examples, and as illustrated, when the handle is in the first position, the gripping portion 131 of the handle 130 lies outside of the optical area 121. This avoids/prevents the gripping portion from blocking the light output from the optical area.

In some examples, the lens comprises a bounding area 122 that surrounds the optical area 121. The bounding area 122 is an area that is configured to not directly receive light emitted by the light emitting element and (if present) the reflector 140. The bounding area 122 may receive, for instance, stray light, e.g., only stray light. In some examples, when the handle is in the first position, the gripping portion of the handle lies inside the bounding area. As the bounding area does not receive light from the light emitting element 110, positioning the gripping portion 131 of the handle 130 of the handle in this location provides no or negligible distortion on the light emitted through the lens 120.

Preferably, when the handle is in the first position, the gripping portion of the handle is inset (i.e., contained within) or inserted within a handle recess 124. In this way, the gripping portion 131 can be positioned or inset into the light outputting side of the LED spotlight lamp. When inside the handle recess, the gripping portion of the handle may be at, or preferably below, the surface of the lens. This approach further reduces the likelihood of the gripping portion 131 of the handle 130 distorting, blocking or performing any other interaction with any light output by the lens 120.

As illustrated, the handle recess 124 may be formed in the lens 120 itself, particularly the bounding area 122 of the lens (if present). This provides a compact approach for insetting the gripping portion 130 of the handle into the light outputting side of the LED spotlight lamp.

In an alternative embodiment, although not illustrated, the handle recess may be formed within the housing 151, e.g., in a part 151A of the housing surrounding the lens 120. This approach maximizes the potential size of the optical area 121 of the lens 120, and can provide or facilitate a more flexible approach for defining optical characteristics of light output by the lens 120.

The illustrated lens 120 further comprises, adjacent to the gripping portion 131 of the handle 130 when the handle is in the first position, a recess 123 for the individual to access the gripping portion of the handle. The recess provides a path for a person's/individual's digit(s) (i.e., finger(s) and/or thumb(s)) to the gripping portion 131 of the handle when the handle 130 is in the first position. The recess increases an ease and convenience of accessing the gripping portion.

The lens 120 may comprise more than one recess, e.g., two recesses. These may be positioned on opposite sides of the lens 120, e.g., diametrically opposite sides of the lens (so that a diameter of the lens spans between the two recesses).

As perhaps best illustrated by FIG. 2, when the handle is in the second position, the gripping portion 131 of the handle 130 may form an arch or arc-shape over the optical area 121. Thus, the gripping portion 131 may be generally U-or C-shaped. This provides a convenient and high-strength shape for gripping by a person/individual, as well as being ergonomic for gripping by the person/individual.

However, it will be appreciated that the gripping portion 131 may have alternative shapes, e.g., an angular shape such as a triangular or square shape. Thus, the gripping portion may be generally V-shaped or [-shaped.

The handle 130 may couple to the remainder of the LED spotlight lamp at opposite or opposing sides of the lens 120.

In preferred examples, the gripping portion 131 of the handle 130 may, when the handle is in the second position, span across or above a diameter of the (e.g., generally circular or cylindrical) lens 120. This approach increases an ease of applying a rotational force

As illustrated in FIGS. 1 to 3, the handle 130 may be coupled to the lens, e.g., at one or more locations around or outside the perimeter of the optical area. Thus, the handle 130 may be rotatably engaged with the lens 120. In particular, the lens 120 and the handle 130 may geometrically co-operate to define one or more hinges that facilitate the rotation of the handle 130 with respect to the lens.

This approach provides good structural integrity for the handle connections, by providing a strong base against which a force can be applied by a person.

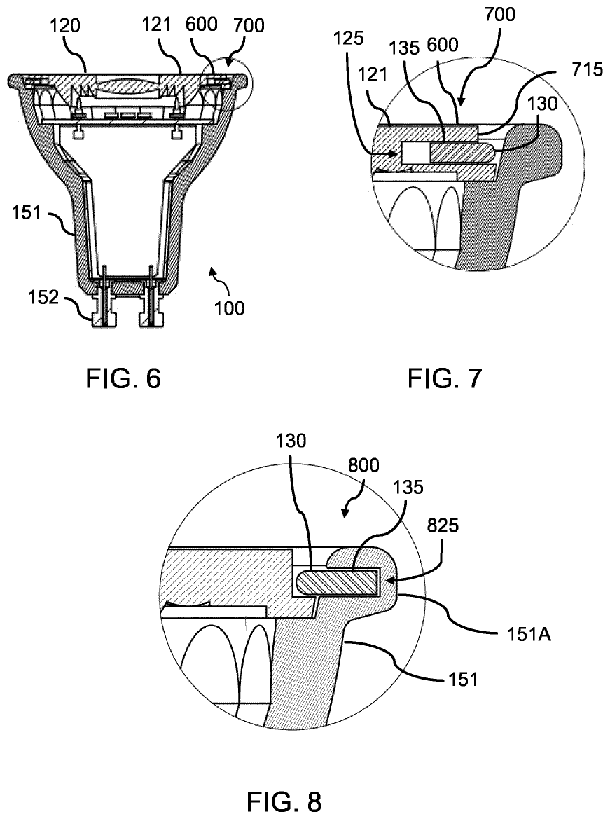

This approach is illustrated by FIGS. 6 and 7. FIG. 6 provides a cross-sectional view of the LED spotlight lamp and FIG. 7 provides a cross-sectional view of part of the LED spotlight lamp, focusing upon a hinge 700 defined by the geometric co-operation of the lens 120 and the handle 130.

The illustrated hinge 700 is formed from a hinge recess 125 (of the lens 120) and a hinge portion 135 (of the handle 130). The hinge portion is rotatable within the hinge recess 125, thereby allowing the handle to rotate with respect to the hinge recess 125, and therefore the lens 120.

The hinge recess 125 is formed in a side edge 715 of the lens 120. The side edge 715 is a rim or outer edge of the lens 120. The hinge portion 135 is a portion of the handle 130 that extends into the hinge recess 125 for rotatable engaging with the hinge recess.

FIGS. 6 and 7 also illustrate an approach in which the hinge recess 125 is formed in a hinge area 600 of the lens 120.

The hinge area 600 is located outside of the optical area, but lies flush with the optical area. This provides a substantially flat surface at the light outputting end of the LED spotlight lamp 100 (when the handle 130 is in the first position). This can, for instance, avoid or reduce a chance of the LED spotlight lamp from being exposed in a light installation, e.g., in which the LED spotlight lamp is recessed within a cavity of a light installation.

In an alternative embodiment, rather than the hinge(s) being defined between the lens and the handle, the housing 151 and the handle 130 may geometrically co-operate to define one or more hinges that facilitate the rotation of the handle 130 with respect to the housing 151.

This approach is illustrated by FIG. 8, which illustrates a cross-sectional view of part of a variation to the LED spotlight lamp, focusing upon a hinge 800 defined by the geometric co-operation of the housing 151 and the handle 130.

The illustrated hinge 800 is formed from a hinge recess 825 (of the housing 151) and a hinge portion 135 (of the handle 130). The hinge portion is rotatable within the hinge recess 825, thereby allowing the handle to rotate with respect to the hinge recess 825, and therefore the housing 120.

The hinge recess 825 is formed in the housing 151. In particular, the hinge recess 825 may be formed in a portion of the housing 151 at the light outputting side of the lamp 100, e.g., adjacent to the lens 120. More particularly, the hinge recess 825 may be formed in a part 151A of the housing surrounding the lens 120.

The hinge portion 135 is a portion of the handle 130 that extends into the hinge recess 825 for rotatably engaging with the hinge recess 825.

Each of the one or more locations (to which the handle couples) may be located at or adjacent to an edge or rim 715 of the lens. This is particularly advantageous when the handle is coupled to the lens 120 itself. This approach maximizes or increases the distance of the location(s) from a rotational axis of the LED spotlight lamp 100, thereby allowing an individual to apply a greater moment/torque (with a same applied force) for rotating the LED spotlight lamp 100 with increased ease, compared to locations closer to the rotational axis of the LED spotlight lamp 100.

It will be apparent to the skilled person that the rotational axis of the LED spotlight lamp 100 is an axis that is parallel to the light output direction 190 and passes through the center (or optical axis) of the lens.

Although only two locations at which the handle connects/couples are illustrated, the locations may comprise only a single location or more than two locations, e.g., to provide increased flexibility for a person attempting to manipulate the LED spotlight lamp using the handle.

Preferably, the number of locations (to which the handle couples) is less than 10, e.g., less than 5. This will reduce or avoid distortion or blocking of light output by the lens. In some examples, the number of locations (to which the handle couples) is exactly 2.

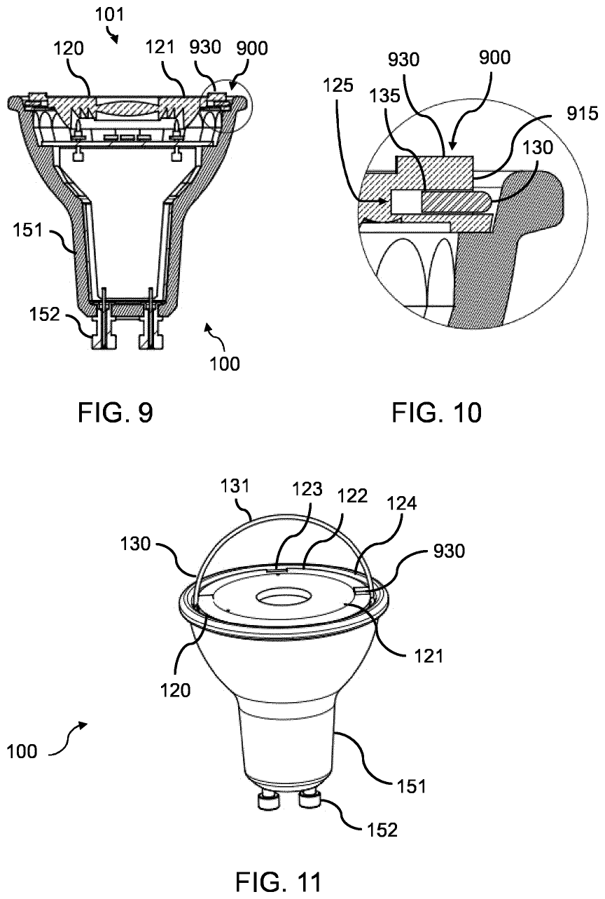

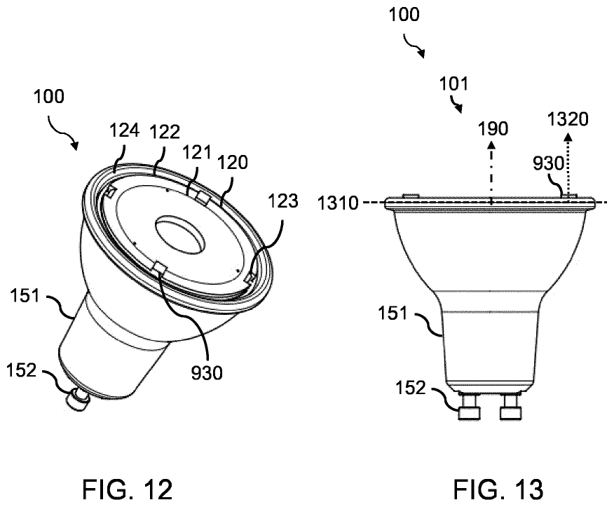

FIGS. 9 to 13 illustrate a modified version of the LED spotlight lamp 100 previously described, with particular reference to the LED spotlight lamp 100 described with reference to FIGS. 1 to 7.

The illustrated variation of the LED spotlight lamp 100 further comprises one or more protrusions 930. Each protrusion 930 extends outwardly from the light outputting end 101 of the LED spotlight lamp 100 and the handle 130 is coupled to the light outputting end 101 of the LED spotlight lamp at the location of each protrusion 930.

Thus, each protrusion can effectively represent a location at which the handle 130 connects to the remainder of the LED spotlight lamp.

The protrusion(s) provide a stronger base for the handle, reducing a likelihood that the base of the handle will snap or break, e.g., when the person applies a rotational force to the handle for rotating the LED spotlight lamp.

The protrusion(s) also provide a secondary region for maneuvering the LED spotlight lens. In particular, each protrusion provides a region or surface for the finger(s) and/or thumb(s) of a person/individual to rest, grip or otherwise engage with to increase an ease of manipulating (e.g., inserting, rotating and/or extracting) the LED spotlight lamp with respect to a lamp socket. This increases an ease for individuals in performing such processes, particularly individuals having mobility concerns or problems.

Interacting with the protrusion(s) may, for instance be useful when the handle is in the first/folded position, but some minor or small maneuvering of the LED spotlight lamp is required (e.g., to re-secure the LED spotlight lamp in place). This can avoid the need for a person/individual to move the handle to the second position to perform such maneuvering of the LED spotlight lamp.

The protrusion(s) also provide a means for maneuvering the LED spotlight lens should the handle break or snap, thereby providing redundancy in facilitating maneuvering of the LED spotlight lens.

The protrusion(s) thereby provide one or more bulges or protuberances on the light outputting end 101 of the LED spotlight lamp 100. The light outputting end 101 will be exposed when the LED spotlight lamp 100 is mounted in a lamp socket. Positioning of the protrusion(s) in this way thereby provides access to a human or person's hand/fingers for ease in installing or removing the lamp to/from the lamp socket.

As illustrated in FIG. 13, the optical area may lie in a first plane 1310 and each protrusion 930 may extend in a direction 1320 substantially perpendicular to the first plane 1310. For instance, each protrusion 930 may extend in a direction 1320 that makes an angle of between 80° and 100° with the first plane 1310. In some examples, each protrusion extends in a direction 1320 that makes an angle of between 85° and 95° with the first plane.

Similarly, as illustrated in FIG. 13, each protrusion 930 may extend in a substantially the same direction as the light output direction 190. Thus, each protrusion 930 may extend in a direction that is substantially parallel to the light output direction 190. In the context of the present disclosure, two directions that extend substantially parallel to one another extend in substantially the same direction (e.g., ±15° or ±10°). This contrasts with substantially anti-parallel directions, which extend in substantially opposite directions (e.g., between 165° and 180° or between 170° and 180° between each direction). As an example, the pins of the plug 152 extend from the LED spotlight lamp in a substantially anti-parallel direction to the light output direction 190.

However, in alternative examples, each protrusion may extend in a direction angled with respect to the light output direction. This can provide a greater surface area for gripping of the protrusion(s) by a person. For example, each protrusion may extend in a direction that makes an angle of between 10° and 60° with respect to the light output direction 190, e.g., between 10° and 45°, e.g., between 30° and 45°.

As illustrated in FIGS. 9 to 13, each protrusion may be formed within the lens 120. Thus, the lens 120 may comprise the protrusion(s) 930.

This approach provides good structural integrity for the protrusion(s), by providing a strong base against which a force can be applied by a person, e.g., via the handle 130 or directly on the protrusion(s). This approach can also provide suitable spacing from an edge of the LED spotlight lamp (e.g., if the housing surrounds the lens) to facilitate ease of gripping the protrusion(s) when the LED spotlight lamp is recessed within a cavity of a light installation, e.g., in scenarios where the lens lies flush with a ceiling or surface or inside a cavity in the ceiling/surface.

In alternative examples, each protrusion 930 may be formed in a part of the housing 151, e.g., a part that surrounds the LED spotlight lamp at the light outputting side 101 of the LED spotlight lamp.

The length of each protrusion, e.g., the distance between the most distal part of the protrusion and the housing/lens, is preferably no less than 1 mm, e.g., no less than 2 mm, e.g., no less than 5 mm. This provides a sufficient and/or suitable size for gripping of the protrusion by a person/individual.

In some examples, the width of each protrusion, e.g., a width in a direction spanning from an edge 125 of the lens to a center of the lens, is less than 50% the radius of the lens, e.g., less than 25% the radius of the lens. This reduces a probable distortion or blocking of light output by the LED spotlight lamp, whilst providing a suitably strong structure for engaging or griping by an individual.

In some examples, at least one side of each protrusion is stepped (i.e., has a stepped profile) or textured. This increases an effective coefficient of friction of the side(s) of the protrusion(s) to increase an ease and strength of gripping of the protrusions by a person, e.g., to prevent or reduce a likelihood of the person's fingers from unintentionally slipping from the protrusion(s) when installing, rotating and/or extracting the LED spotlight lamp from a lamp socket.

The at least one side preferably includes at least one side that faces a direction of rotation of the LED spotlight lamp 100 about the rotational axis (which is parallel to the light output direction 190) of the LED spotlight lamp. Thus, the at least one side may include at least one side that faces a direction that is tangential to the lens 120.

Each protrusion may have a sloped side. The sloped side slopes towards the center of the lens 120 and/or a rotational axis 510 of the LED spotlight lamp 100. The sloped side increases an amount of contact between a person engaging with the protrusion(s), e.g., due to the natural shape of a thumb/finger, thereby increasing an amount of grip. The sloped side also reduces a chance of the protrusion(s) snapping or breaking, by increasing a size of the base relative to the tip and reducing a sideways pressure that is likely to be applied to any individual portion of the protrusion(s) during gripping. Thus, a more robust one or more protrusions are provided.

The sloped side may be textured and/or stepped (i.e., have a stepped profile). This increases the effective surface friction of the sloped side.

Each protrusion may comprise a straight side, i.e., a side that is substantially parallel with the light output direction.

FIGS. 6 to 10 also illustrate how the housing 151 is configured to mount and support the various other elements of the LED spotlight lamp 100. In particular, the housing may be configured to engage with an edge, corner or rim of the lens 120 in order to secure the lens 120 to the housing. Thus, the housing may surround or encircle the lens in order to engage with the lens 120.

The present invention is particularly advantageous when the LED spotlight lamp is a GU or GZ type lamp. This is because such lamps are typically installed in recessed cavities (e.g., in a ceiling or wall), in which the light outputting side of the LED spotlight lamp is designed to lie flush with a boundary of the cavity. This makes it difficult to manipulate the lamp during installation or extraction, e.g., to connect the plug to the lamp socket within the recessed cavity. The (rotatable) handle facilitates improved grip of the LED spotlight lamp during installation and extraction, to thereby increase an ease of performing these processes. The present invention is even more advantageous when the LED spotlight lamp is a GU-10 or GZ-10 type lamp. This is because such lamps require insertion and rotation into a lamp socket for correct and effective installation (e.g., to perform a twist-and-lock maneuver), and similarly requires rotation and removal of the lamp from the lamp socket for extraction of the lamp. Providing the (rotatable) handle for additional grip increases an ease of performing both of these process, particularly rotating the LED spotlight lamp within a lamp socket to secure or lock the lamp to the lamp socket.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A LED spotlight lamp comprising:
a light emitting element comprising one or more light emitting diodes for generating light; and
a lens comprising an optical area for receiving light emitted by the light emitting element and directing the received light out of a light outputting end of the LED spotlight lamp in a light output direction; and
a handle comprising a gripping portion for being gripped by a person, the handle being coupled to the light outputting end of the LED spotlight lamp at one or more locations, the handle being configured to be rotatable between at least:
a first position, in which the gripping portion of the handle lies against the light outputting end of the LED spotlight lamp; and
a second position, in which the gripping portion of the handle extends outwardly from the light outputting end to facilitate gripping of the LED spotlight lamp by the person for inserting, rotating and/or extracting the LED spotlight lamp with respect to a lamp socket;
wherein the handle is coupled to the lens at one or more locations around or outside the perimeter of the optical area;
wherein the lens and handle geometrically co-operate to define one or more hinges to facilitate rotation of the handle with respect to the lens;
wherein each of the one or more hinges, comprises:
a hinge recess being a recess inside a side edge of the lens; and
a hinge portion being a portion of the handle that extends into the hinge recess for rotatably engaging with the hinge recess.

2. The LED spotlight lamp of claim 1, wherein the one or more locations are locations around or outside the perimeter of the optical area.

3. The LED spotlight lamp of claim 1, wherein, when the handle is in the first position, the gripping portion of the handle lies outside of the optical area.

4. The LED spotlight lamp of claim 1, wherein:
the lens comprises a bounding area which surrounds the optical area, and is configured to not directly receive light emitted by the light emitting element; and
when the handle is in the first position, the gripping portion of the handle lies inside the bounding area.

5. The LED spotlight lamp of claim 1, wherein the lens further comprises, adjacent to the gripping portion of the handle when the handle is in the first position, a recess for the person to access the gripping portion of the handle.

6. The LED spotlight lamp of claim 1, wherein, when the handle is in the first position, the gripping portion of the handle is inset or inserted within a handle recess.

7. The LED spotlight lamp of claim 1, wherein, when the handle is in the second position, the gripping portion of the handle forms an arch over the optical area.

8. The LED spotlight lamp of claim 1, wherein the hinge recess is formed in a hinge area of the lens outside of the optical area, wherein the hinge area lies flush with the optical area.

9. The LED spotlight lamp of claim 1, further comprising one or more protrusions wherein each protrusion extends outwardly from the light outputting end of the LED spotlight lamp and the handle is coupled to the light outputting end of the LED spotlight lamp at the location of each protrusion.

10. The LED spotlight lamp of claim 9, wherein the optical area lies in a first plane and each protrusion extends in a direction substantially perpendicular to the first plane.

11. The LED spotlight lamp of claim 1, configured and arranged as a GU/GZ LED spotlight lamp.

12. The LED spotlight lamp of claim 11, configured and arranged as a GU-10 lamp or a GZ-10 lamp.
